(19) United States
(12) Patent Application Publication
(10) Pub. No.: US 2010/0290578 A1
(43) Pub. Date: Nov. 18, 2010

(54) DEPLOYABLE ELECTRIC ENERGY REACTOR

(75) Inventors: J. Paul Farrell, East Setauket, NY (US); James R. Powell, Shoreham, NY (US)

Correspondence Address: HOFFMANN & BARON, LLP, 6900 JERICHO TURNPIKE, SYOSSET, NY, 11791, US

(73) Assignee: RADIX POWER AND ENERGY CORPORATION, East Setauket, NY (US)

(21) Appl. No.: 12/778,326

(22) Filed: May 12, 2010

Related U.S. Application Data
(60) Provisional application No. 61/177,465, filed on May 12, 2009.
(60) Provisional application No. 61/181,123, filed on May 26, 2009.

(51) Int. Cl. G21C 1/08; G21C 3/00; G21C 9/00; G21C 7/06; G21C 19/00

(52) U.S. Cl. 376/361; 376/409; 376/288; 376/219; 376/260

(57) ABSTRACT

A nuclear fission reactor device including a core having an array of fissile material and which is capable of being transported to and from the place of operation using conventional transportation vehicles. In a first embodiment, the fissile material is a uranium hydride enriched 15%-to-20% with U-235. In a second embodiment, the fissile material is a uranium oxide enriched to 18% to 20% with U-235.

This application claims the benefit of U.S. Provisional Application Ser. No. 61/177,465 filed May 12, 2009 and U.S. Provisional Application Ser. No. 61/181,123 filed May 26, 2009, the disclosures of which are hereby incorporated by reference in their entirety.

### BACKGROUND OF THE INVENTION

The present invention relates to deployable electric energy reactors and, more particularly, to a compact readily deployable nuclear reactor system for providing secure emergency power in both civilian and military applications.

With respect to civilian applications, those skilled in the art will recognize that the U.S. electricity system is a very complex, highly interdependent network of large power plants and long transmission lines that requires constant and precise control. Disruption can rapidly propagate through the infrastructure, causing major portions to fail, as seen in the past. Such events have been triggered by natural causes. Global terrorism raises the possibility of deliberate physical attacks against power plants, transmission lines, sub-stations, and other critical government or civilian facilities. Terrorism also includes the possibility of cyber attacks against the computers that control such systems. Domestic military bases that depend on the civilian electric grid cannot function if it goes down for extended times. Natural disasters like hurricanes Katrina and Rita, and earthquakes such as in Haiti in 2010, have shown the need for secure emergency power. If nuclear, biological, or chemical attacks on cities were to occur, panic and evacuations could shut down much of the U.S. electric system for many months.

In addition, the conventional wisdom about the U.S. electric system has been that larger-sized power plants (whether fossil fuel or nuclear) can produce electrical power at a cost per kilowatt hour that is less than the cost associated with smaller plants. Accordingly, there has been a tendency to build larger power plants and, for safety, aesthetic and social-political reasons, to locate these larger plants at a distance from the population centers to be powered. These very large power systems incorporate many inherent disadvantages, namely, site preparation, separate radiation shield, size of containment building, time and cost of construction, one-of-a-kind control system, location near large body of water for cooling purposes, and others.

With respect to military applications, smaller-sized nuclear power plants have been built for submarines and aircraft carriers. However, outside of those applications, the military has generally relied upon conventional means of generating power, e.g., the use of diesel generators. More particularly, when operating in remote areas for long periods of time (e.g., deployments in Iraq and/or Afghanistan) the military is often required to continuously run generators, typically burning diesel fuel. The largest of these diesel generators are on the order of 750 kilowatts, and require a constant supply of diesel fuel, which in a remote setting is often difficult (as well as expensive) to provide.

Accordingly, there is a need in the art for a deployable electric energy reactor which can provide secure emergency power for both civilian and military applications. There is a further need in the art for a deployable electric energy reactor which is both compact and quickly deployable using existing types of transport vehicles. Finally, there is a need in the art for a deployable electric energy reactor, which can be transported from the deployment site after shut down with very low and acceptable radiation doses to the handling and transport personnel.

### SUMMARY OF THE INVENTION

The present invention, which addresses the needs of the prior art, relates to compact transportable nuclear power systems and application modules that can be rapidly deployed to sites, using existing air and ground transport, to generate electric power, condense fresh water from the atmosphere, and manufacture fuel, fertilizer, and other needed materials. The nuclear reactor may operate, without refueling, for periods up to ten (10) years at low power or for periods up to two (2) years at full rated power.

The nuclear power systems are comprised of a pressurized light water reactor (PLWR) steam generator, turbine, and condenser with water to air or water to water heat exchanger. The reactors can be transported to and from their deployment site even after shutdown, with very low and acceptable radiation doses to handling and transport personnel.

Two distinct nuclear reactor systems are described. The baseline Deployable Electric Energy Reactor (DEER) system uses commercial TRIGA® (low-enriched (up to 20%), uranium zirconium hydride (UZrH_{1.6})) fuel, with water coolant at standard PWR conditions¹. The DEER reactor can operate for several years without refueling, or it can operate for up to 10 years or more at reduced power level. After shutdown, it is removed to an appropriate site for refueling or disposal. If needed, a new DEER reactor can be installed at the location. The advanced Ultra compact, Ultra high power Deployable Electric Energy Reactor (DEER-U2) system uses existing TRISO² fuel particles in porous fuel elements with direct fluid cooling of the particles. After shutdown, the spent TRISO fuel particles are hydraulically unloaded into a compact shielded transport cask for disposal. Fresh TRISO fuel particles are then loaded for the next operating cycle. DEER and DEER-U2 use up to 20% enriched fuel, and operate for years per fuel loading. The reactor modules and separate steam turbine-generator modules are preferably integrated at the operating site. In one embodiment, turbine inlet conditions are saturated steam at 1000 psi. If only air cooling is available at the operating site, turbine exhaust pressure is preferably 15 psi, with a thermal cycle efficiency of 25%. If water cooling is available, turbine exhaust pressure is preferably 2 psi, with a cycle efficiency of 30%. ¹ Low-enriched, long-lifetime uranium zirconium hydride (UZrH) fuel is an important feature of the TRIGA® family of reactors. The large prompt negative temperature coefficient of reactivity characteristic of UZrH_{1.6} fuel results in safety margins far above those achieved by any other research reactor fuel. Large reactivity insertions are readily accommodated and are routine operation for some applications. Inadvertent reactivity insertions have been demonstrated to produce no fuel damage in TRIGA cores. Power coast-down from full power after loss of forced flow cooling (and resultant power scram) has been demonstrated to be a very benign event with the reactor immediately available to return to full power.² INEEL/EXT-05-02615, “Development of Improved Models and Designs for Coated-Particle Gas Reactor Fuels,” Idaho National Engineering and Environmental Laboratory, December 2004

In one preferred embodiment, the system includes a core of UZrH_{1.6} fuel enriched up to 20% with U-235. The system preferably includes an atmosphere of flowing water passing through the core, and a pressure vessel for containing the core and the water coolant at pressure in the range 1500 psig (100 atmospheres=10 MPa). The system further includes an integral conformal radiation shield that has a thickness and density sufficient to attenuate the high energy gamma rays emitted by the core during operation and after the reactor is shut down. Moreover, the system preferably includes a set of movable control rods containing a neutron absorbing material for controlling release of energy from the core. Finally, the system preferably has a total reactor weight which allows transportation on conventional vehicles.

In another preferred embodiment with the potential to operate at a peak thermal power of 40 megawatts, the core is cylindrically shaped and measures approximately 50 cm to 60 cm in diameter and approximately 55 to 65 cm in height. The core is preferably separated by a gap of approximately 0.5 cm to 1.5 cm from a conformal coaxial neutron reflector. In turn, the core is preferably enclosed in a conformal neutron reflector having a thickness of approximately 5 cm. The neutron reflector is in turn preferably enclosed in an integral conformal pressure vessel having a thickness of at least about 3.0 cm of steel. The pressure vessel is in turn preferably enclosed in a conformal integral radiation shield having a thickness of at least about 20 cm to 25 cm of high density material such as tungsten or tantalum.

In another preferred embodiment with the potential to operate at a peak thermal power of 200 megawatts, the core is cylindrically shaped and measures approximately 120 cm in diameter and approximately 120 cm in height. The core is preferably separated by a gap of approximately 0.5 cm to 1.5 cm from a coaxial neutron reflector. In turn, the core is preferably enclosed in a conformal neutron reflector having a thickness of at least about 5 cm. The neutron reflector is in turn preferably enclosed in an integral conformal pressure vessel having a thickness of at least about 3.0 cm of steel. The pressure vessel in turn is preferably enclosed in a conformal integral radiation shield having a thickness of at least about 20 cm to 25 cm of high density material such as tungsten or tantalum.

In another preferred embodiment, the present invention relates to a nuclear fission reactor system with a core including an array of cylindrical fuel elements that contain Tristructural-isotropic (TRISO) fuel particles enriched up to 20% with U-235. The core preferably includes an array of porous fuel elements, for containing the TRISO fuel particles. The system preferably includes an atmosphere of flowing coolant passing through the core. The system also preferably includes a pressure vessel that contains the core and the coolant at a pressure in the range of 1500 psig (100 atmospheres=10 MPa). The system preferably includes a set of movable control rods containing a neutron absorbing material for controlling release of energy from the core. Finally, the system preferably has a total reactor weight which allows transportation on conventional vehicles.

In another preferred embodiment, the fuel elements are formed from coaxially-arranged porous cylinders, with the TRISO particles being packed into the annular space between the two cylinders. Preferably, the inlet coolant flows directly into and along the central cylindrical channel of each fuel element and then radially outwards through the porous cylinder wall into the annular-packed particle beds, and then out of the particle beds into the body of the pressure vessel, removing the fission heat from the TRISO particles. The TRISO fuel particles are preferably transferred hydraulically between a separate external storage cask and the reactor fuel assembly. The system preferably includes a fuel transfer cask including an outer radiation shield having two coaxial porous cylinders with an annular space between the inner and outer cylinders.

As a result, the present invention provides a deployable electric energy reactor for providing secured emergency power in both civilian and military applications. The present invention further provides a system that is compact and quickly deployable using existing types of transport vehicles. Finally, the present invention provides deployable electric energy reactors having integral gamma shields, which can be transported from their deployment site after shut down with very low/acceptable radiation doses to the handling and transport personnel.

### BRIEF DESCRIPTION OF THE DRAWINGS

FIG. 1 is a schematical view of the modular components of the present invention;

FIG. 2 is an elevation view of a 10 MW(e) DEER reactor formed in accordance with the present invention;

FIG. 3 is a cross-sectional view of the core of the reactor of FIG. 2;

FIG. 4 is a graphical representation showing the critically constant, K_{eff}, verses operating time for a 10 MW(e) DEER Reactor using TRIGA fuel;

FIG. 5 is a graphical representation showing the afterheat of the 10 MW(e) reactor as a function of time after shut down;

FIG. 6 is a graphical representation of the gamma dose rates after 1,000 hours of operation as a function of the distance from the surface of the reactor;

FIG. 7 is a graphical representation of the temperature of the hot fuel element as a function of the distance from the inlet;

FIG. 8a is a cross sectional view of the core of the ultra high power, ultra compact DEER-U2 reactor;

FIG. 8b is a cross sectional view of the fuel element;

FIG. 8c is an elevation view of the fuel element showing the fluid flow paths;

FIG. 9 is an elevation view of a fuel storage/transport cask for the DEER-U2 reactor; and

FIG. 10 is a cross-sectional view of the fuel storage/transport cask of FIG. 9.

### DETAILED DESCRIPTION OF THE INVENTION

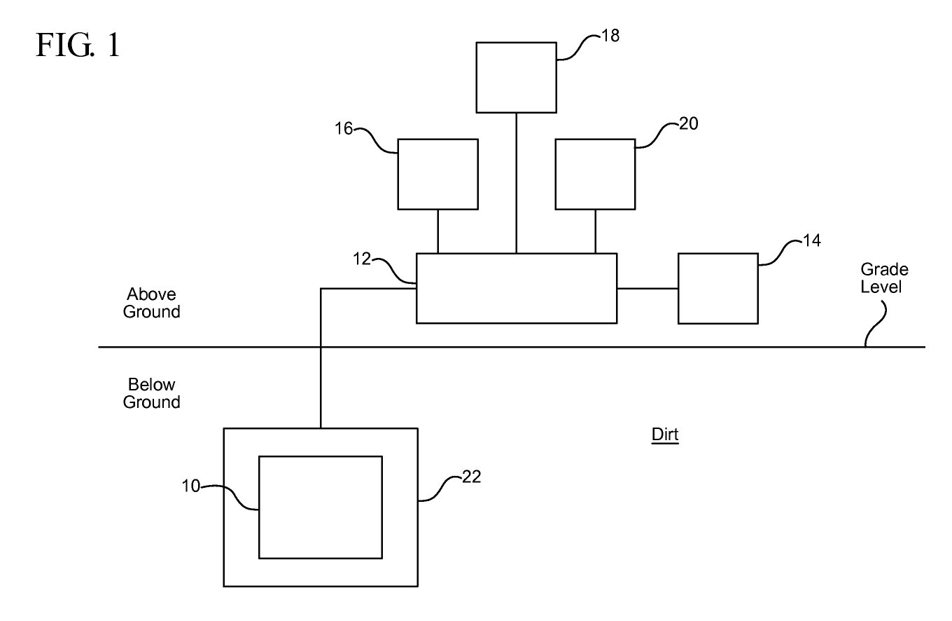

Referring to FIG. 1, the deployable nuclear reactor systems of the present invention preferably include a reactor module 10, a power conversion module 12, a waste heat rejection module 14, and depending on needs of the operating site, a set of process modules 16, 18, 20—which can be used for production of fresh water, hydrogen fuel, synthetic vehicle fuel and/or ammonia, the ammonia being used for vehicle fuel and/or for production of fertilizer.

Power conversion module 12 can include any known apparatus for converting high temperature fluid (liquid or gas) to a usable source of output power (e.g., electricity) such as a steam turbine generator. Waste heat rejection module 14 is preferably configured to work in conjunction with power conversion module 12 to facilitate a thermodynamic cycle. When used in conjunction with a steam turbine generator, the waste heat rejection module 14 will condense the turbine exhaust steam using coolant water (if available), or by using an air cooled heat exchanger. The various process modules would be used under appropriate circumstances. It will be appreciated by those skilled in the art that the module design of the system facilitates transportation, assembly and disassembly of the individual components, and allows the system to be readily configured on site in the desired manner with the desired parameters.

As shown in FIG. 1, the reactor module 10 is preferably positioned below ground level and/or within an enclosure 22 formed of cement or other suitable shielding material. The location of reactor module 10 at an underground position provides additional shielding for the DEER reactor, and as discussed further hereinbelow, provides the necessary shielding for the DEER-U2 reactor during operation. It will also be appreciated that the location of the reactor module 10 at an underground position provides an additional level of security against tampering, and in battlefield locations, can provide an additional level of protection against attempted sabotage and/or directed military strikes.

The first embodiment of the present invention, i.e., the DEER system, is a fully sealed reactor using UZrH_{1.6} fuel. The DEER reactor is not refueled at the site. After reaching its reactivity limited lifetime, the reactor module will be transported away for refueling or disposal and a new module brought to the site, if desired. For disaster relief, one reactor module per mission would likely be sufficient. For power/water/fuel/fertilizer production, additional modules would be necessary. The removed DEER module has an integral gamma shield that limits radiation dosage to handling and transport personnel to values well below existing guidelines. There is no residual radioactivity at the operating site after the end of the mission.

The second embodiment of the present invention, i.e., the DEER-U2 design, uses TRISO fuel particles that are hydraulically unloaded from the reactor after shutdown, enabling periodic refueling even though the reactor vessel is sealed. The particle unloading/loading uses small diameter pipes that are valved shut during operation. Spent TRISO fuel particles are loaded into a compact, fully shielded transport cask. The shielding for the DEER-U2 reactor may include dirt, sand, water or other locally available material. Because the DEER-U2 reactor does not require an integral shield, the DEER-U2 system weighs much less than that DEER system. The DEER-U2 reactor can remain at a site for as long as power output is needed.

There are two preferred DEER reactor sizes, namely 10 MW(e) and 50 MW(e). The 10 MW(e) module's thermal power is 40 MW(th), based on a cycle efficiency of 25%, and a turbine exhaust pressure of 15 psi for waste heat reaction to the atmosphere. The 50 MW(e) module's thermal power is 200 MW(th). If water cooling is available, the power outputs would be 12 MW(e) and 60 MW(e), respectively.

The DEER-U2 reactor uses well developed Tristructural-isotropic (TRISO) fuel. The TRISO fuel consists of a fuel kernel composed of UO₂ (i.e. UOX) (sometimes UC or UCO) in the center, coated with four layers of three isotropic materials. The four layers are a porous buffer layer made of carbon, followed by a dense inner layer of pyrolytic carbon (PyC), followed by a ceramic layer of SiC to retain fission products at elevated temperatures and to give the TRISO particle more structural integrity, followed by a dense outer layer of PyC. TRISO fuel particles are designed not to crack due to the stresses from processes (such as differential thermal expansion or fission gas pressure) at temperatures beyond 1600° C., and therefore can contain the fuel in the worst of accident scenarios in a properly designed reactor. The TRISO nuclear fuel consists of small particles, each about 30 mils (0.7 millimeter) in diameter. The TRISO particles are packed into fuel elements and are directly cooled by a fluid medium, e.g., water, helium, argon. The packed particles in the DEER-U2 fuel elements can be hydraulically unloaded and fresh particles loaded back, enabling the reactor to be periodically refueled without opening the pressure vessel. Ten (10) and 50 MW(e) designs of the DEER and DEER-U2 power levels bracket the range of interest and maximum weight for deployable systems. If more than 50 MW(e) is desired at a site, additional units could be deployed.

The DEER-U2 reactor is designed to produce high power with less size and weight than the DEER reactor. Furthermore, the DEER-U2 reactor is designed to be more readily transportable using conventional vehicles and to have a fuel system that can be reloaded in situ.

### The Deer Reactor

TABLE I
Preferred Design Parameters for the DEER Reactor

| Reactor Parameters | 10 MW(e) | 50 MW(e) |
|---|---|---|
| Thermal Power MW(th) | 40 | 200 |
| Cycle Efficiency (%) | 25 | 25 |
| Reactor OD (m) | 0.63 | 1.30 |
| Module OD (m) with 0.2 (m) Shield | 1.09 | 1.74 |
| Reactor Core OD (m) | 0.53 | 1.2 |
| Reactor Core Length (m) | 0.6 | 1.2 |
| Fuel Element Diameter (cm) | 0.9 | 1 |
| Fuel Elements in Core # | 2078 | 5149 |
| Uranium in UZrH_{1.6} Fuel (Wt. %) | 30 | 30 |
| Uranium Wt. in Core (kg with 20% U-235 | 37 | 226 |
| Enrichment) | | |
| Reactor Wt. w/Fuel (metric tons) | 1.3 | 7.4 |
| Module Wt. w/Shield (metric tons) | 13 | 40 |

Computer simulations were used to determine the design parameters of the DEER modules using MCNP³ Monte Carlo code and MonteBurns⁴ Monte Carlo code, both of which are available to those skilled in the art. The MCNP Monte Carlo code models criticality, power distribution, control rod worth, void coefficient, temperature coefficient, etc. with great accuracy, while the MonteBurns Monte Carlo code follows the neutronic behavior of the reactor over its operating life as the U-235 fuel burns out and fission products build up. Three dimensional Monte Carlo neutronic analyses are accurate and predict reactor performance with high precision. Monte Carlo predictions of the various neutronic parameters for the SNTP/PBR nuclear propulsion reactor, which is comparable in size to the DEER reactors, agreed at the 1% level with experimental measurements on the actual PBR critical assemblies. ³ MCNP—A General Monte Carlo N-Particle Transport Code, Version 4C, J. F. Breismelster, Ed., Los Alamos National Laboratory, LA 13709-M, March 2000.⁴ D. L. Poston, and H. R. Trellue: User's Manual, Version 2.0 for MONTEBURNS Version 1.0, LA-UR-99-4999 (September 1999)

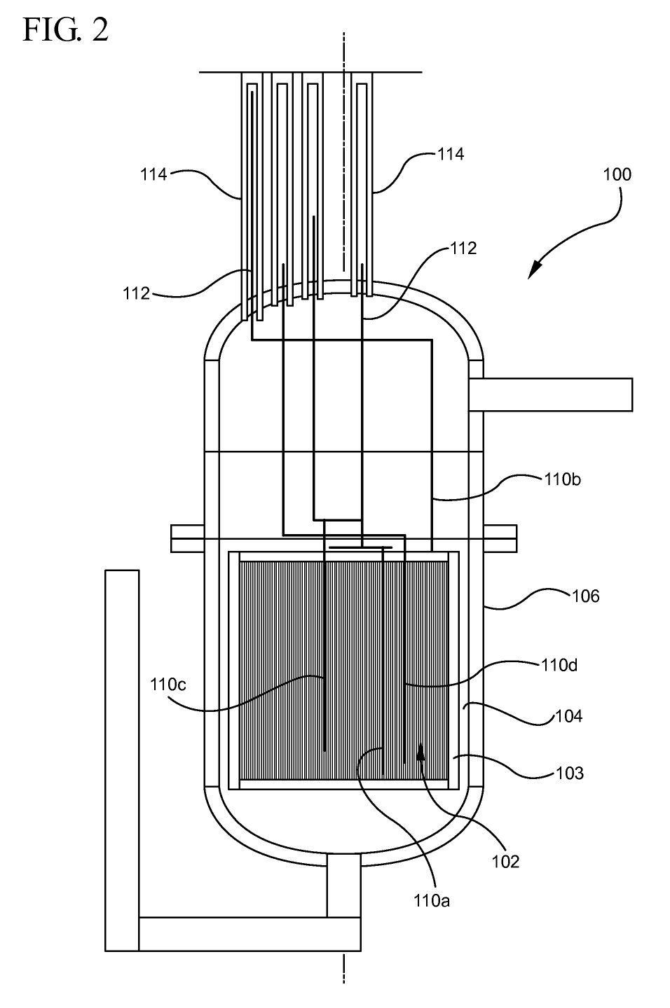

Referring now to FIGS. 2-3, a 10 MW(e) DEER reactor 100 includes a core 102, a reflector 104, a pressure vessel 106 and a shield 108 (shown in FIG. 3). The core is cylindrically shaped and measures approximately 50 cm to 60 cm in diameter and approximately 55 to 65 cm in height. As best seen in FIG. 3, core 102 is preferably separated by a gap 103 of approximately 0.5 cm to 1.5 cm from conformal coaxial neutron reflector 104. In turn, conformal neutron reflector 104 preferably has a thickness of approximately 5 cm, and is preferably formed by the pressurized water contained within the pressure vessel. Neutron reflector 104 is in turn preferably enclosed in an integral conformal pressure vessel 106 having a thickness of at least about 3 cm of steel. Pressure vessel 106 is in turn preferably enclosed in a conformal integral radiation shield 108 having a thickness of at least about 20 cm to 25 cm of high density materials such as tungsten or tantalum. A plurality of fuel rods 109 are positioned in core 102.

A plurality of movable control rods 110a, b, c, d are located inside of pressure vessel 106. The control rods can be moved between a first position wherein they are fully extended within core 102 (see control rod 110 a) and a second position wherein they are fully withdrawn from core 102 (see control rod 110 b). The control rods are preferably formed from a neutron absorbing material such as boron, which limits/prevents the fission process when the control rods are fully inserted into the core. When the control rods are fully withdrawn from the core, the reactor will operate at maximum power. The power of the reactor can be regulated by moving one or more control rods into the core. In one embodiment, each of control rods 110a, b, c, d may be individually adjusted to provide greater adjustability of the power output of the reactor. The control panel for moving the control rods is preferably located external to the pressure vessel, and communicates with a drive mechanism 112 located inside the pressure vessel whereby the control rods can be moved into and out of the core without any breaches of the pressure vessel. A plurality of housings 114 preferably extend from the pressure vessel to provide the vertical height necessary to allow the contact rods to be fully withdraw from the core.

In one preferred embodiment, fuel rods 109 are arranged in a symmetric matrix within the core and the control rods are concentrated toward the center of the core. In another preferred embodiment, the matrix is formed with a pentagonal cross-section.

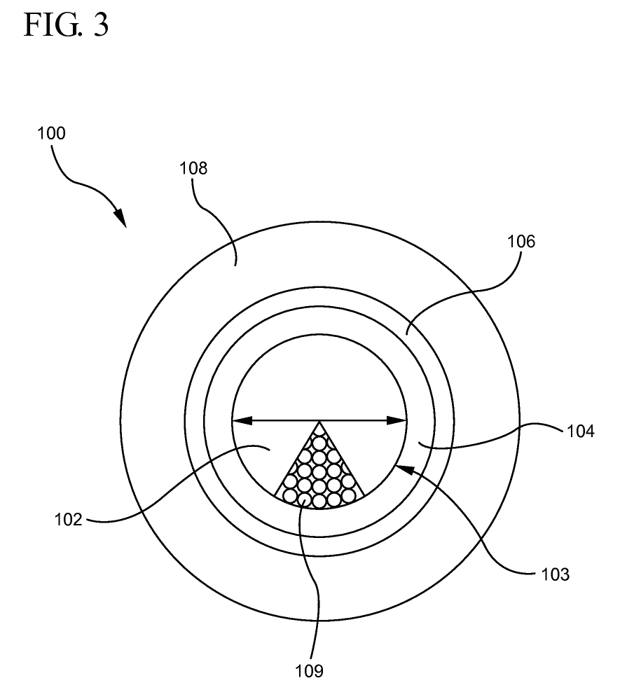

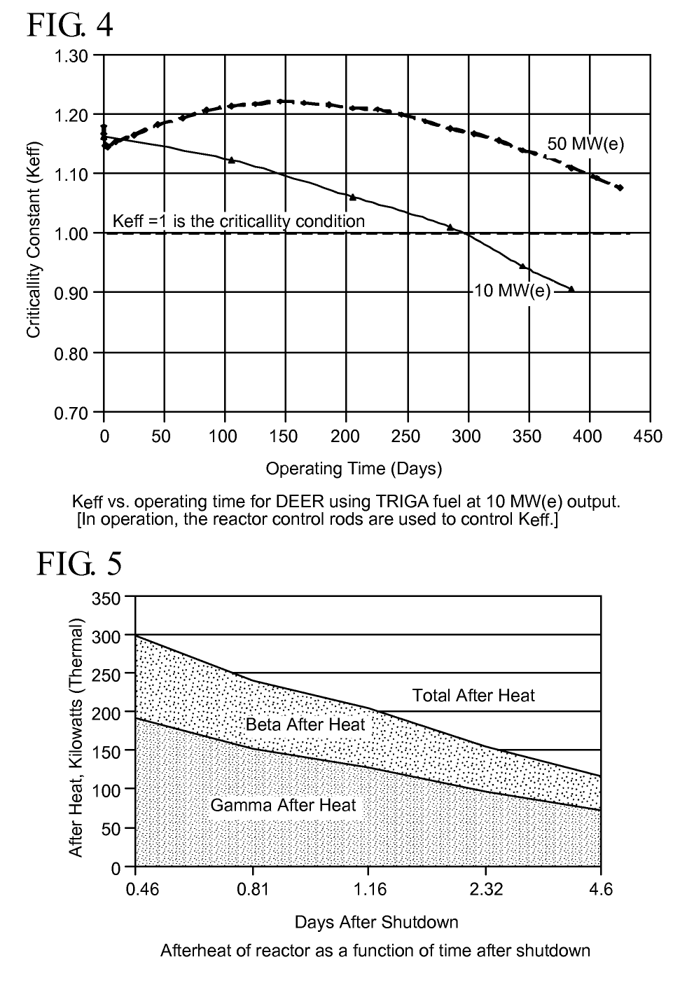

FIG. 4 shows the criticality constant, K_{eff} as a function of time for the 10 and 50 MW(e) designs, as predicted by the MCNP and MonteBurns codes. The DEER reactor operates as long as K_{eff} is greater than, or equal to 1.00 (when K_{eff} is greater than 1.00, control rods keep the actual K_{eff}=1.00). The DEER fuel contains a burnable neutron poison to minimize the swing in K_{eff} over reactor lifetime. For the 10 MW(e) design, K_{eff} reaches its limit of 1.00 after 300 days of full power operation. At this point, the DEER reactor would be removed and transported to a site to be refueled or decommissioned.

The Monte Burns analysis indicates that the 50 MW(e) reactors will operate considerably longer—well over 425 days—and likely up to 600 days before replacement. If the reactor does not always operate at full output, the reactor module would not require replacement until its integrated output reached 300 full power days for the 10 MW(e) design and ˜600 full power days for the 50 MW(e) unit. Also, the designs assume a 30 weight percent loading of uranium in the UZrH_{1.6} hydride fuel. Higher uranium weight loadings are practical, up to at least 45%, which could double operation lifetime. The DEER fuel enrichment is up to 20% U-235, which is not usable for nuclear weapons. Twenty percent (20%) enriched fuel is widely used and does not require safeguards. When the DEER reactor is shut down and transported away from its operating site, thermal energy generation will continue from the radioactive decay of its fission products. This small afterheat continues to decrease with time after shutdown.

FIG. 5 shows the afterheat thermal power following shutdown for the 10 MW(e) DEER reactor. Two days after shutdown, the thermal power is 150 kilowatts, about 0.3% of the 40 megawatts generated at full power. Approximately one-third is from short range beta particles, which stop inside the reactor, and two-thirds is from gamma photons, which require shielding. Contributions of gamma and beta radiation are shown separately. The calculations are based on 10 MW(e) [40 MW (thermal)] after 1000 hours of operation.

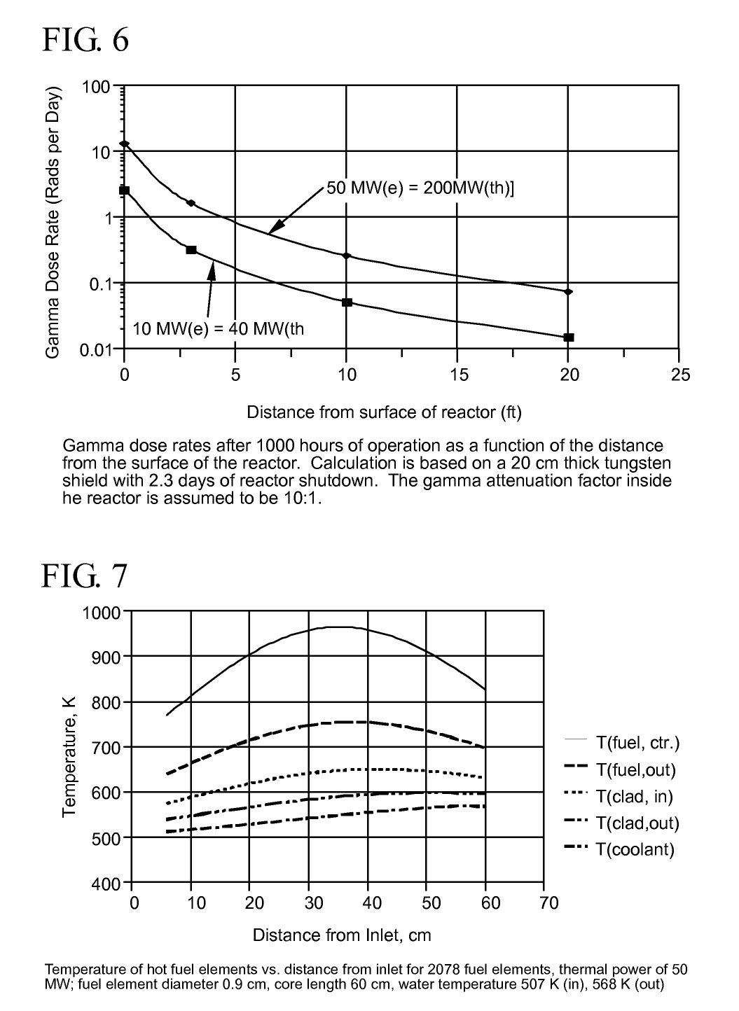

The DEER reactors have an enclosing thick tungsten or tantalum gamma shield that attenuates the external dose from the radioactive fuel inside the shut-down reactor, so that personnel can safely remove and transport it away from the site. FIG. 6 shows the gamma dose in rads per day as a function of distance from the shield surface, based on a 20 centimeter thick shield at 2.3 days after shutdown. For the 10 MW(e) reactor, at 10 feet the radiation dose is 0.05 rad per day. The allowable dose for radiation workers is 5 rads per year. To receive this dose, the worker would have to remain at 10 feet from the shield for 100 days, assuming the dose rate stayed constant at the 2.3 day level. However, since the afterheat and gamma photon release rate rapidly decrease with time, the worker would not receive 5 rads—no matter how long the worked remained in proximity to the reactor. The dose rate for the 50 MW(e) reactor is ˜0.25 rad per day. At 10 feet for 20 days, a worker would receive 5 rads at the 2.3 day release rate.

FIG. 7 shows the temperature distribution along the fuel element located at the center of the DEER reactor core, which has the greatest power density, as a function of distance from the coolant inlet. Maximum temperature at the center of the fuel element is 970 K, well below the maximum temperature capability of the TRIGA fuel, and comparable to the maximum temperature for steady state operation in previous TRIGA reactor designs. The heat transfer analyses shown in FIG. 7 illustrates the ΔT's for the various steps in the heat transfer process, i.e. the ΔT from the center of the hydride fuel to the outer surface of the fuel, the ΔT between the outer surface of the hydride and the inner surface of the stainless steel cladding, the ΔT across the water film from the outer surface of the cladding to the bulk of the water coolant. The largest ΔT is that between the center of the hydride fuel and its outer surface, being about 200 K at the center of the reactor. The analysis was for a thermal power of 50 MW, an early design version of the MW(e) unit. The present thermal rating is 40 MW(th), which reduces each of the ΔT's by a factor of 0.8, making the maximum fuel temperature ˜900 K.

### The Deer-U2 Reactor

TABLE II
Preferred Design Parameters for the DEER-U2 Reactor Based on Fuel
Elements with Hydraulically Loaded/Unloaded TRISO Particles

| Reactor Parameters | 10 MW(e) | 50 MW(e) |
|---|---|---|
| Thermal Power (MW) | 40 | 200 |
| Cycle Efficiency (%) | 25 | 25 |
| Reactor OD (cm) | 65 | 92 |
| Reactor Core OD (cm) | 45 | 71 |
| Reactor Core Length (cm) | 100 | 176 |
| # of Fuel Elements in Core | 37 | 91 |
| Fuel Element OD (cm) | 6.0 | 6.0 |
| Thickness of TRISO Bed in Fuel Element | 1.45 | 1.45 |
| (cm) | | |
| Average Power Density in TRISO Bed | 0.78 | 0.78 |
| MW(th)/liter | | |
| Initial U-235 Loading in Core (kg) | 14.6 | 73.0 |
| 50% Burnup Lifetime (mos.) | 6 | 6 |
| Weight of Reactor, incl. Fuel (metric tons) | 1.25 | 4.5 |

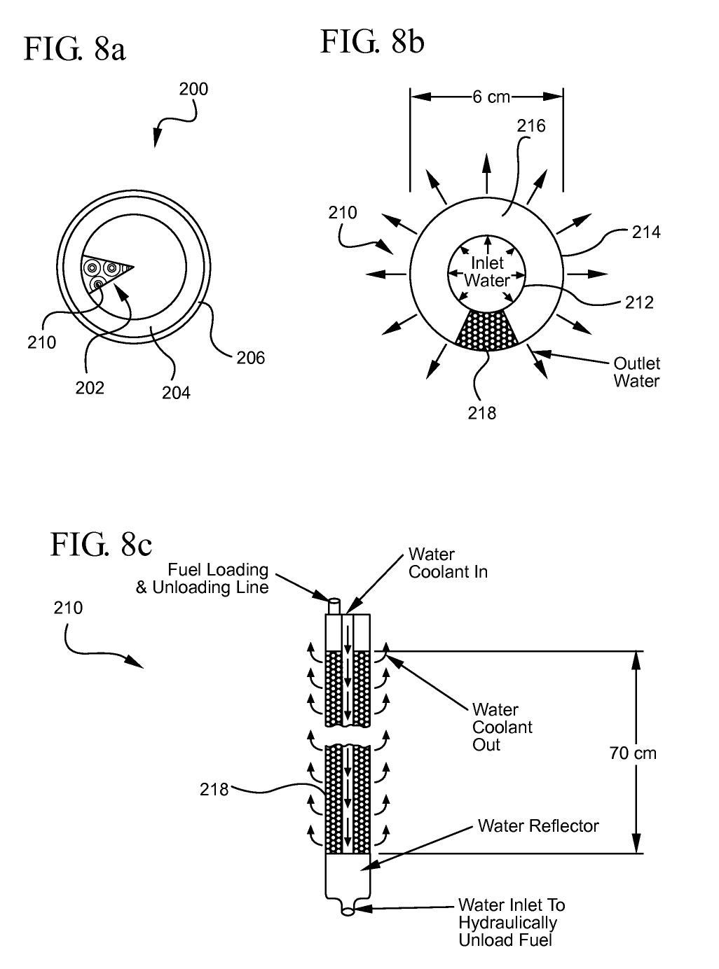

FIGS. 8a-8c illustrate the DEER-U2 reactor. Referring to FIG. 8a, DEER-U2 reactor 200 includes a reactor core 202, a neutron reflector 204 and a pressure vessel 206. A plurality of fuel elements 210 are positioned within the reactor core. As explained further hereinbelow, reactor 200 does not require and/or include an integral shield—although an outer shield layer can be added to attenuate small residual radiation levels.

Those skilled in the art will recognize that the materials used to shield a nuclear reactor are extremely dense and heavy, thereby forming the substantial portion of the overall weight of the reactor. In other words, when considering a transportable nuclear reactor, such as the DEER reactor discussed hereinabove, the 10 MW(e) unit weighs approximately 13 metric tons with the integral shield, whereas the reactor alone weights approximately 1.3 metric tons. Although small and light enough to be transportable, the DEER reactor discussed hereinabove nonetheless weighs 13 metric tons, which requires a certain level of equipment for transportation and handling thereof. The ability to eliminate the integral shield from the reactor unit substantially reduces the weight of such unit, thereby greatly increasing the transportability and ease of handling of the unit. Stated differently, transporting and handling a reactor weighing 1.3 metric tons is substantially easier than transporting and handling a reactor weighing 13 metric tons. The requirement to preload a transportable reactor with fuel necessitates the need for an integral shield, and thus the overall weight of the unit.

The ability to remove the integral shield from the reactor is accomplished through the design of the novel fuel elements of the DEER-U2 reactor, together with the usage of fuel having certain characteristics. More particularly, the DEER-U2 reactor has been designed such that it can be loaded with the necessary fuel after it is has been transported to the selected site, and after it has been configured and setup. This setup would involve installing the DEER-U2 reactor below ground and/or within a protected enclosure. Due to the light weight of the DEER-U2 reactor, this installation/setup is readily accomplished. Once setup, the fuel is then loaded into the reactor core (as discussed hereinbelow), whereby a fission reaction can be initiated. The surrounding dirt and/or enclosure provide the necessary shielding while the reactor is in use. If and when it is time to remove the reactor from the selected site, the radioactive fuel is unloaded from the reactor core in the reverse manner, thereby leaving the reactor core empty of radioactive material. The reactor core can thereafter be removed from the site with no risk to the personnel transporting the unit.

As discussed earlier, the DEER-U2 reactor uses small TRISO nuclear fuel particles that are hydraulically loaded into and out of the reactor. In the DEER-U2 system, the fuel elements are designed so that the TRISO fuel particles can be hydraulically unloaded and loaded. The small diameter of the TRISO particles enables them to be hydraulically loaded into and removed from fuel element structures inside the reactor, without the need to physically open the reactor. The DEER-U2 reactor includes a plurality of fuel elements 210 positioned within core 202. As best shown in FIGS. 8b and 8c, each fuel element 210 includes an inner cylinder 212, and an outer cylinder 214. An annular space 216 is thereby defined between the outer surface of cylinder 212 and the inner surface of cylinder 214. The TRISO fuel particles 218 are packed within annular region 216. Each of cylinders 212 and 214 are porous in design whereby a coolant fluid can pass through the walls of the cylinders. As best seen in FIG. 8c, a coolant fluid (e.g., water) is directed into inner cylinder 212. The water travels through the porous walls of inner cylinder 212 into annular region 216. The water thereafter flows through the walls of porous outer cylinder 214 whereby it then exits the reactor core 202.

The TRISO fuel is packed into annular region 216 between two porous cylinders. In operation, water coolant flows in through and along the central channel inside the inner cylinder. The coolant then flows radially outwards through the packed bed of TRISO particles to exit from the reactor. The pores are chosen small enough to contain the TRISO particles but large enough to provide sufficient cooling. Pore size is chosen to control individual coolant flow at every (r,θ,z) location on each fuel element.

The TRISO fuel is transported to and from the reactor vessel in a separate shielded transport cask. The fuel is then hydraulically transferred between the transport cask and the fuel elements located inside the reactor pressure vessel. In the fuel unload transfer mode, the reactor water coolant is directed in through the bottom of the fuel element, fluidizing the settled particle bed and causing the particles to flow out with the water through the top of element into the external spent fuel storage cask. To hydraulically load fresh fuel particles into the DEER-U2 reactor, the fluidized particles are introduced into the top of the elements. The down-flowing particles are then trapped by the porous frit at the bottom of each element, building up the annular bed in the element.

The inlet water coolant flows along the central cylindrical channels inside the particle bed fuel elements and then radially outwards through the annular packed particle beds, removing the fission heat from the TRISO particles. The annular particle bed is held between two coaxial cylindrical porous frits, which form the fuel element.

The pressure drop for water flow through the fits is preferably several times greater than the pressure drop through the particle bed so that each local portion of the bed experiences the proper water flow rate, and the temperature of the water coolant existing through the outer frit is essentially the same everywhere in the reactor. Frits are preferably configured to control individual coolant flows at every (r,θ,Z) location on each fuel element in the reactor core so that the outlet coolant is at the same temperature everywhere.

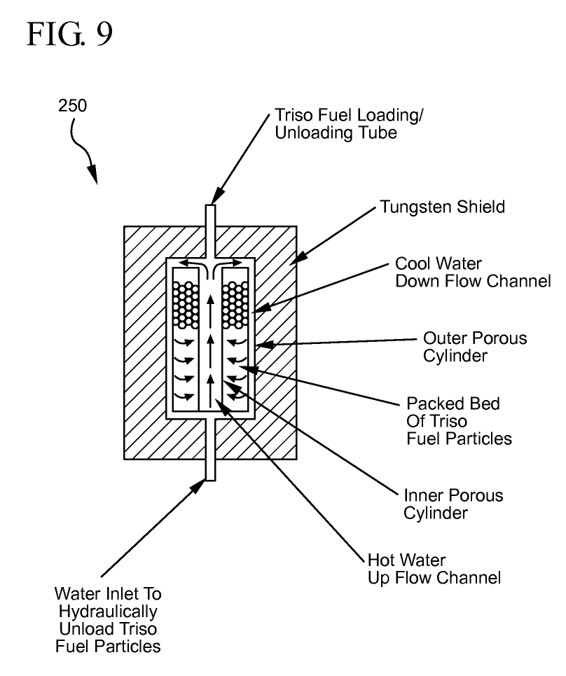

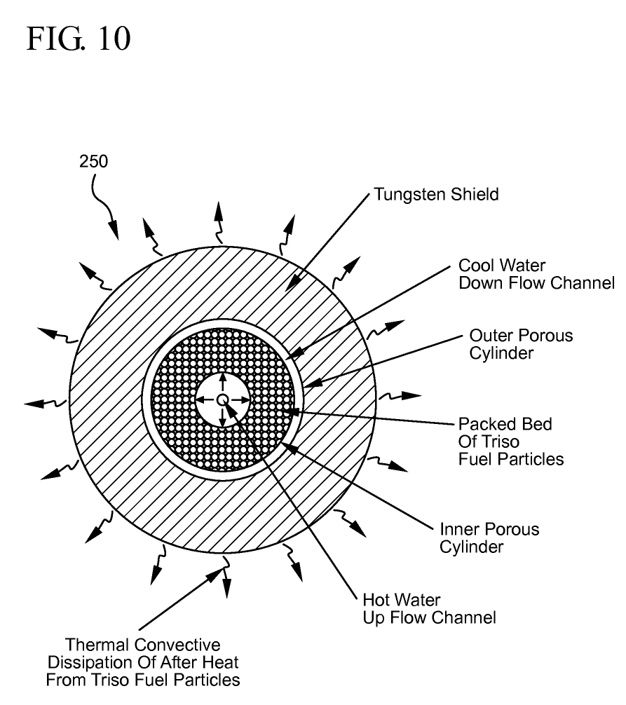

FIGS. 9-10 show a fuel storage/transport cask 250 for the 10 MW(e) DEER-U2 TRISO reactor. The spent TRISO fuel particles are immersed in liquid water inside the enclosing shield/container vessel. The shield attenuates the gamma radiation enough from the fission products that the handling/transport personnel do not receive excessive radiation dosages. The decay heat deposited in the TRISO fuel particles (primarily from beta particle decay, which is about one-third of total decay heat) is transferred to the water bath in which the particles are immersed, and then by convection to the shield.

Although the storage/transport casks do require shielding, which substantially increases the weight of such cask, it will be appreciated that the weight of a shielded cask will be substantially less than the weight of a shielded reactor such as the DEER reactor described hereinabove. Moreover, it will be appreciated that multiple smaller-sized casks may be used to load a DEER-U2 reactor, rather than one larger cask. In this manner, the size and weight associated with each discrete cask can be designed within preselected parameters. In one preferred embodiment, the individual casks are sized to have a weight on the order of one ton whereby the transportation/lifting equipment can easily move all such components.

This energy, plus the gamma energy deposited in the shield, is then conducted through the shield to the outer surface of the cask. From there, natural convection, which may be augmented by fans, transfers the thermal energy to the ambient atmosphere. Natural convection currents in the water bath transfer the thermal energy to the inner surface of the shield. In an alternative embodiment, the natural convection currents are augmented with a small electrically powered circulator.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

What is claimed is:

1. nuclear fission pressurized light water reactor, comprising:
a reactor core, said reactor core including a plurality of uranium zirconium hydride fuel rods, each of said fuel rods having a diameter of approximately 1 cm and being arranged in a symmetric matrix;
a pressure vessel surrounding said core, said pressure vessel having an external conformal radiation shield made of a heavy metal, said pressure vessel including penetrations for inlet and outlet flow of pressurized water; and
a plurality of control rods located within said pressure vessel and movable between a first position wherein said control rods are extended within said matrix to limit fission within said core and a second position wherein said control rods are withdrawn from said matrix to allow fission within said core.

2. The nuclear fission reactor according to claim 1, wherein
said uranium zirconium hydride fuel rods are formed of up to 20% U-235 enriched uranium and up to 45% ratio of uranium to zirconium by weight.

3. The nuclear fission reactor according to claim 2, wherein
said radiation shield is made of a tungsten alloy said alloy being segmented into semicircular sections, said semicircular segments having an axial length of approximately 10 cm, said semicircular segments having interlocking ends such that opposite segments can be joined together to form a complete 360 degree circular segment enclosing an approximately 10 cm axial length of the pressure vessel.

4. The nuclear fission reactor according to claim 2, wherein
said radiation shield is made of a tantalum alloy, said alloy being segmented into semicircular sections, said semicircular segments having an axial length of approximately 10 cm, said semicircular segments having interlocking ends such that opposite segments can be joined together to form a complete 360 degree circular segment enclosing an approximately 10 cm axial length of the pressure vessel.

5. The nuclear fission reactor according to claim 2, wherein said matrix is formed with a pentagonal cross-section.

6. The nuclear fission reactor according to claim 2, further comprising a controller located external to said pressure vessel for moving said control rods between said first and second positions.

7. The nuclear fission reactor according to claim 6, wherein said control rods are formed from a neutron absorbing material.

8. A nuclear fission reactor, comprising:
a reactor core, said reactor core including an array of fuel elements containing tristructural-isotropic fuel particles, said fuel particles being enriched up to 20% with U-235, said fuel elements being formed from axially-arranged porous cylinders, said cylinders defining an annular region therebetween and wherein said fuel particles are packed into said annular region; and
a pressure vessel surrounding said core, said pressure vessel including penetrations for inlet and outlet flow of a coolant through said core.

9. The nuclear fission reactor according to claim 8, wherein said coolant is water, said water operating at pressure in the range of 1500 psi (100 atmospheres=10 MPa).

10. The nuclear fission reactor according to claim 8, wherein said coolant is a pressurized flowing gas under a nominal pressure on the order of 1000 psi.

11. The nuclear fission reactor according to claim 10, wherein said gas is helium

12. The nuclear fission reactor according to claim 10, wherein said gas is argon.

13. The nuclear fission reactor according to claim 8, wherein said coolant flows into the interior of the inner cylinder of said fuel element and thereafter flows through the porous wall of the inner cylinder into said annular region containing said fuel particles thereby removing the fission heat generated by said fuel particles.

14. The nuclear fission reactor according to claim 8, further comprising an external transfer cask for holding and storing said fuel particles; and
wherein said fuel is transferred hydraulically between said cask and said fuel elements, said cask including an outer radiation shield having two coaxial porous cylinders with an annular space between the inner and outer cylinders.

15. The nuclear fission reactor according to claim 14, further comprising means to hydraulically transfer said fuel particles between said fuel transfer cask and said fuel elements located in said core.
